(19) United States
(12) Patent Application Publication
(10) Pub. No.: US 2019/0248205 A1
(43) Pub. Date: Aug. 15, 2019

(54) Air Freight Temperature Controlled Device Using Liquid Nitrogen

(71) Applicants: William G Moon, Provo, UT (US); John J Hammerman, Bozeman, MT (US)

(72) Inventors: William G Moon, Provo, UT (US); John J Hammerman, Bozeman, MT (US)

(21) Appl. No.: 15/893,487

(22) Filed: Feb. 9, 2018

(51) Int. Cl. B60H 1/00; F25B 9/14; B64D 37/04; B64D 37/16; B64D 37/30

(52) U.S. Cl. CPC B60H 1/00014; F25B 9/14; B64D 37/04; B64D 37/16; B64D 37/30; F25B 2309/003; F17C 2270/0189; F17C 2223/033; F17C 2227/0313; F17C 2227/0346; F17C 2227/0353; F17C 2227/0379; F17C 2205/0323

(57) ABSTRACT

Systems and methods are disclosed for transporting products with an airplane by controlling temperature in a payload bay using cryogenic coolant and a heat exchanger to cool the payload bay and heat from a heater; recycling exhaust from the heat exchanger to power a Stirling engine; charging a storage device with power from the Stirling engine; housing the payload bay as part of a modular, stackable module in an aircraft bay for transportation; and venting exhaust gas to an exterior of the airplane.

### FIELD OF SYSTEM

The present invention relates to temperature-controlled air freight type unit load devices (ULD).

### BACKGROUND OF THE SYSTEM

The airline industry has been using Unit Load Devices (ULD) for decades. It allows a large quantity of cargo to be bundled into a single unit, saving ground crews time and effort. However, these units typically are not temperature controlled. Perishable items such as fruits and vegetables, fresh meats and fish, flowers, and plants typically will be damaged in flight without a temperature-controlled environment. The current temperature controlled ULDs require the inconvenience of replacing ice or dry ice, or being plugged into a power box for 6 hours per recharge.

### SUMMARY

In one aspect, systems and methods are disclosed for transporting products with an airplane by controlling the temperature in a ULD payload bay using cryogenic coolant and a heat exchanger to cool, and an electrical power source and heating element to heat the ULD payload bay; and providing electrical power to a storage device by means of a gas turbine generator and a Stirling engine; and housing the payload bay as part of a modular, stackable module in an aircraft bay for transportation.

Implementations of the above aspect may include one or more of the following: The system is powered by liquid nitrogen which heats or cools the payload bay as required to maintain a constant temperature for the customer's product. Vacuum Insulated Panels (VIPs) thermally isolate the payload bay from the harsh, rapid, and extreme temperature changes typically experienced in airline cargo areas. The system is autonomous and can operate without additional power for up to 10 days. Refueling is accomplished with a cryogenic bulk tank or service truck. Sensors are deployed to report temperature to a remote computer for monitoring the temperature of the payload and shock encountered throughout the shipping duration, among others.

In another aspect, cryogenic tanks are connected in parallel to a heat exchanger and a Stirling engine. Two solenoid valves determine the flow of liquid nitrogen through the heat exchanger for cooling and the Stirling engine for electric power. The solenoid valves are energized and opened by the controller and operate independently when there is a demand for cooling or a demand for recharging the deep cycle batteries. An additional source of electrical power is provided by a gas turbine generator that is powered by the exhaust from both the heat exchanger and the Stirling engine. A thermal sensor inside the payload bay communicates the current temperature to the controller. An electric heating element is placed in the same airflow path as the heat exchanger. A fan blows air through both the the heat exchanger for cooling and the electric heating element for heating. Storage devices such as deep cycle batteries are charged by a Stirling engine generator and a gas turbine generator to provide power for the electric heating element, fan, control electronics, data storage and telemetry. The ULD has an exhaust port and the exhaust nitrogen gas is vented outside the ULD. The gas may be vented directly into the cargo area or a hose may be used to vent the gas to a quick connect port that vents to the outside of the airplane.

In another aspect, when liquid nitrogen is prohibited during flight, the ULD can be precooled or preheated before takeoff. During flight, liquid nitrogen will not be stored, used, or exhausted by the ULD. The ULD will still maintain the setpoint, within a few degrees, without the use of coolant. This method of operation is referred to as “Passive Shipping”. Prior to flight, the ULD is connected to a cryogenic bulk tank or service truck for coolant and to an electrical power source, such as a generator or AC outlet to recharge the deep cycle batteries and also supply power to the heating element when there is a demand for heat. The ULD is then operated in a cooling or heating capacity until the predetermined shipping setpoint is attained. The coolant and power are disconnected and the ULD is loaded into the cargo area of the airplane with no liquid nitrogen in the ULD cryogenic tanks. During flight, the ULD will maintain the setpoint temperature within a few degrees, because the ULD is extremely well insulated with state-of-the art Vacuum Insulated Panels that significantly reduces heat flow into or out of the ULD. When there is a demand for heat during Passive Shipping, the deep cycle batteries power the electric heating element. Without liquid nitrogen as a power source, the Stirling engine and gas turbine generator do not operate. Therefore, the heating capability in Passive Shipping mode will be less than normal, but sufficient, to maintain the predetermined setpoint temperature to within a few degrees. After landing the ULD is again connected to a coolant and power source wherein cooling or heating resumes to bring the ULD exactly to the predetermined setpoint temperature. The cryogenic tanks in the ULD may also be refilled at this time for autonomous operation during transport to the final destination.

In another aspect, when the airline company not only restricts the use of liquid nitrogen but also restricts empty cryogenic tanks during flight, then the cryogenic tanks are removed from the ULD.

In yet another aspect, an alternative method of cooling is known as Direct Inject. The liquid nitrogen is sprayed into the payload bay. The design eliminates the heat exchanger and utilizes a tube with a multiplicity of nozzles. When there is a demand for cooling, the solenoid valve is energized, and the liquid nitrogen flows from the cryogenic tanks, through the solenoid valve, through the tube, and sprays through the nozzles and into the payload bay. The liquid nitrogen evaporates and provides extremely efficient cooling. The evaporated nitrogen gas increases the pressure of the payload bay, forcing the exhaust nitrogen gas through a vent pipe. But since the air in the cargo area of the airplane is continuously recycled with external air, oxygen depletion is not a significant concern. In certain aircraft, there may be a quick connect port that vents outside the airplane. The ULD vent hose is attached to that port, and the exhaust nitrogen vents outside the airplane, further reducing oxygen depletion concerns. The advantages of Direct Inject are faster and more efficient cooling. The disadvantages are extremely cold spots on product near the cryogenic spray and non-uniform distribution of cooling throughout the payload bay.

Advantages of the temperature controlled ULD invention may include one or more of the following: The system provides a temperature-controlled environment to protect perishable products throughout the duration of airline flights and longer. The system provides cooling or heating for a large ULD and can maintain a constant internal temperature in the cargo area temperature environment that ranges from 50 deg C. on runways to −40 deg C. at flight altitudes. The ULD only requires a refill of liquid nitrogen once a week, which takes about 15 minutes. The system is easy to use, and the liquid nitrogen can be filled by the normal procedure used to fill cryogenic tanks in the field. The system avoids the need for extended (6 hour) power hookups or for replacing ice or dry ice.

### BRIEF DESCRIPTION OF THE DRAWINGS

FIG. 1 shows an exemplary piping and instrument diagram of the ULD in a refueling and recharging state connected to a cryogenic bulk storage tank and a portable generator

FIG. 2 shows an exemplary cross section view of the top of the ULD.

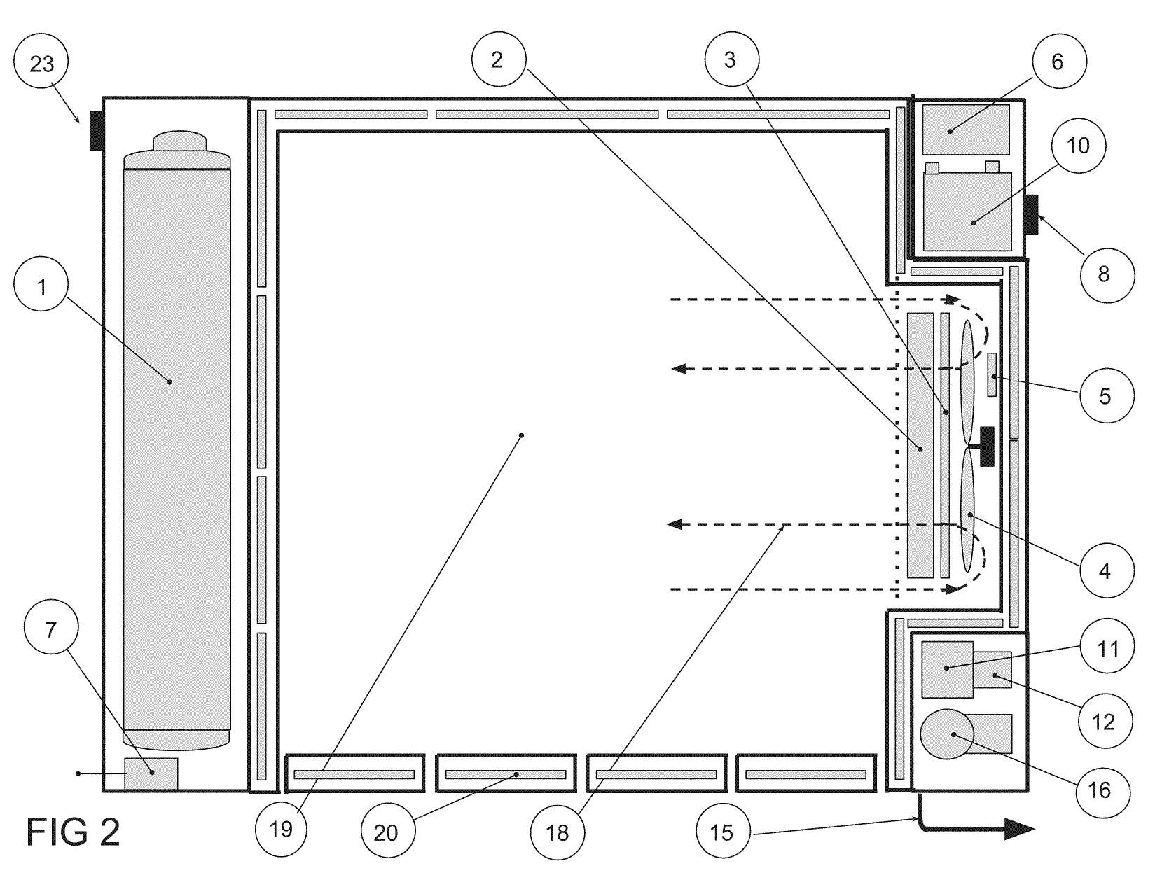

FIG. 3 is an exemplary cross section view of the side of the ULD.

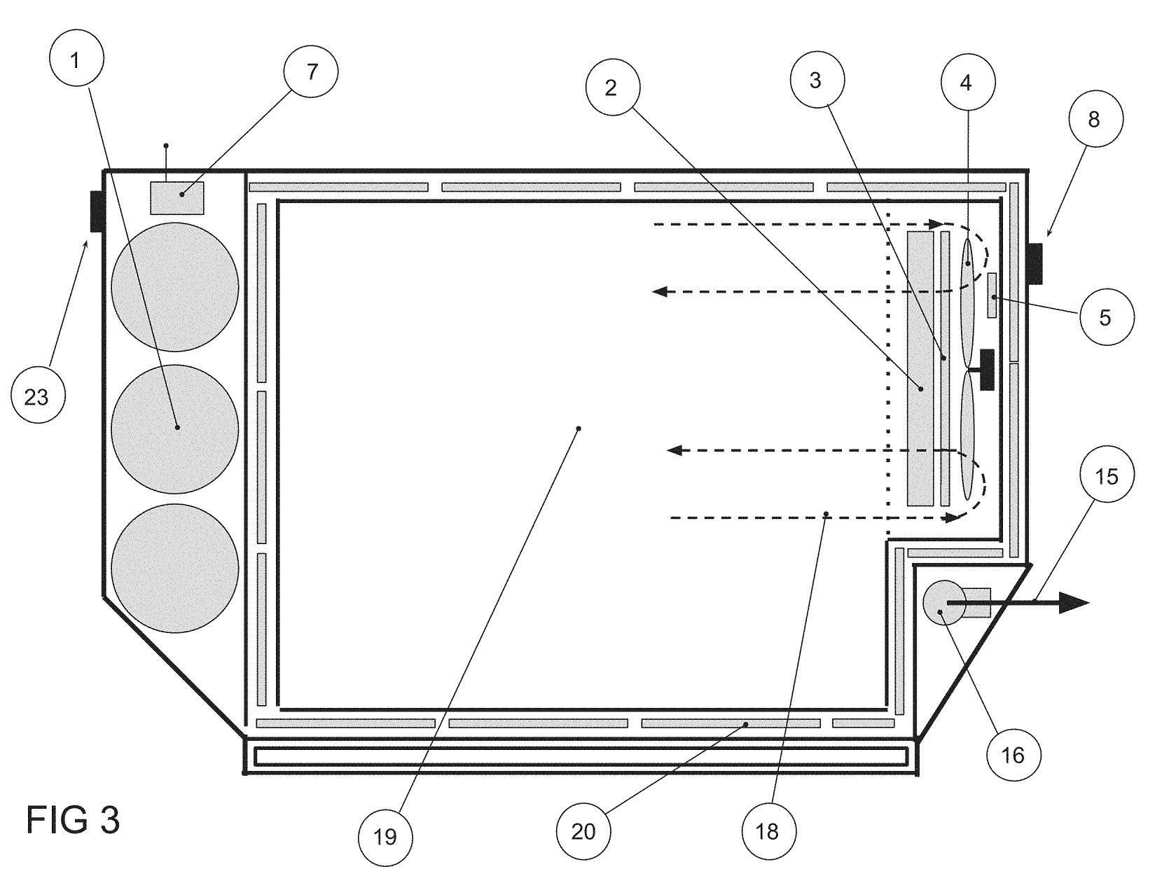

FIG. 4 shows a perspective view of the ULD.

FIG. 5 shows a perspective view of the ULD during refueling and recharging.

FIG. 6 shows a perspective view of the ULD in an aircraft.

FIG. 7 shows a piping and instrument diagram of the Passive Shipping ULD in a pre-boarding state, connected to a cryogenic bulk tank and a portable generator.

FIG. 8 shows a piping and instrument diagram of the Direct Inject ULD.

### DETAILED DESCRIPTION

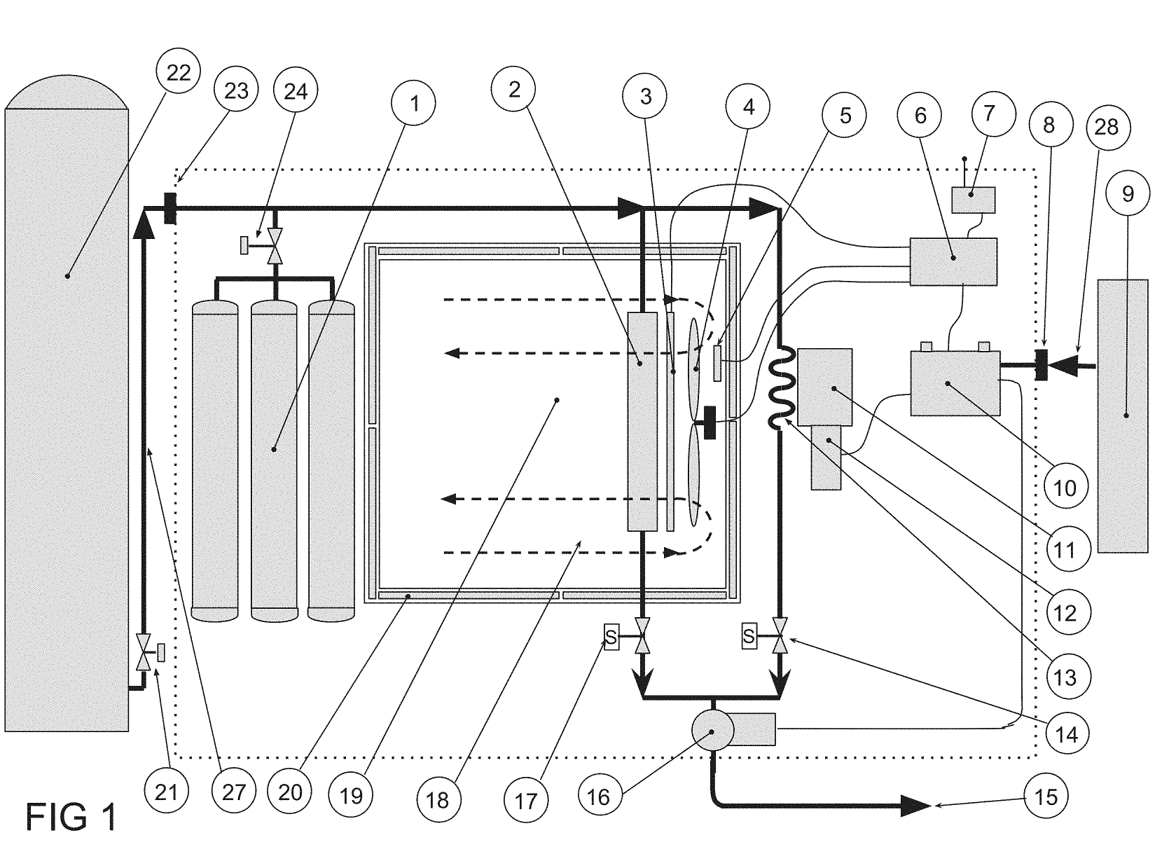

Turning now to the figures, in one embodiment, FIGS. 1,2,3 & 4 show details of an air freight temperature-controlled unit load device (ULD). In general, the ULD has a plurality of cryogenic tanks 1 connected to each other in a parallel type orientation, a shut off valve 24 and a tube connecting the cryogenic tanks to a heat exchanger 2. When there is a call for cooling from a controller 6, a solenoid valve 17 opens the flow of liquid nitrogen from the cryogenic tanks 1 through the heat exchanger 2. The unit also has a Stirling engine 11 to regeneratively charge power storage devices such as deep cycle batteries 10 that provide electrical power to the ULD. A tube connects the cryogenic tanks to a Stirling engine cold sink 13, and a solenoid valve 14 is connected to the Stirling engine plumbing that opens the liquid nitrogen flow through the Stirling engine cold sink 13 when there is a call to recharge deep cycle batteries 10 that supply power to the ULD. A gas turbine generator 16 operates whenever there is gas flow, and contributes power to recharge deep cycle batteries 10. An electric heating element 3 is powered by deep cycle batteries 10. When there is a demand for heat an electric heating element 3 is energized by controller 6. A fan 4 positioned inside a payload bay 19 is powered by deep cycle batteries 10, for uniform convective heating and cooling. A controller 6 in conjunction with a thermal sensor 5 in a payload bay 19 for temperature feedback, controls solenoid valves 14 & 17 to adjust the temperature to a predetermined setpoint in a payload bay 19. A payload bay 19 is isolated from the cargo environment with a double wall and Vacuum Insulated Panels 20 placed between the walls. An exhaust hose 15 vents the ULD to the cargo area or to a quick connect port that vents outside the airplane. The unit can have an operational data recorder and transmitter 7 to log temperature as well as damages arising from dropping the ULD, for example.

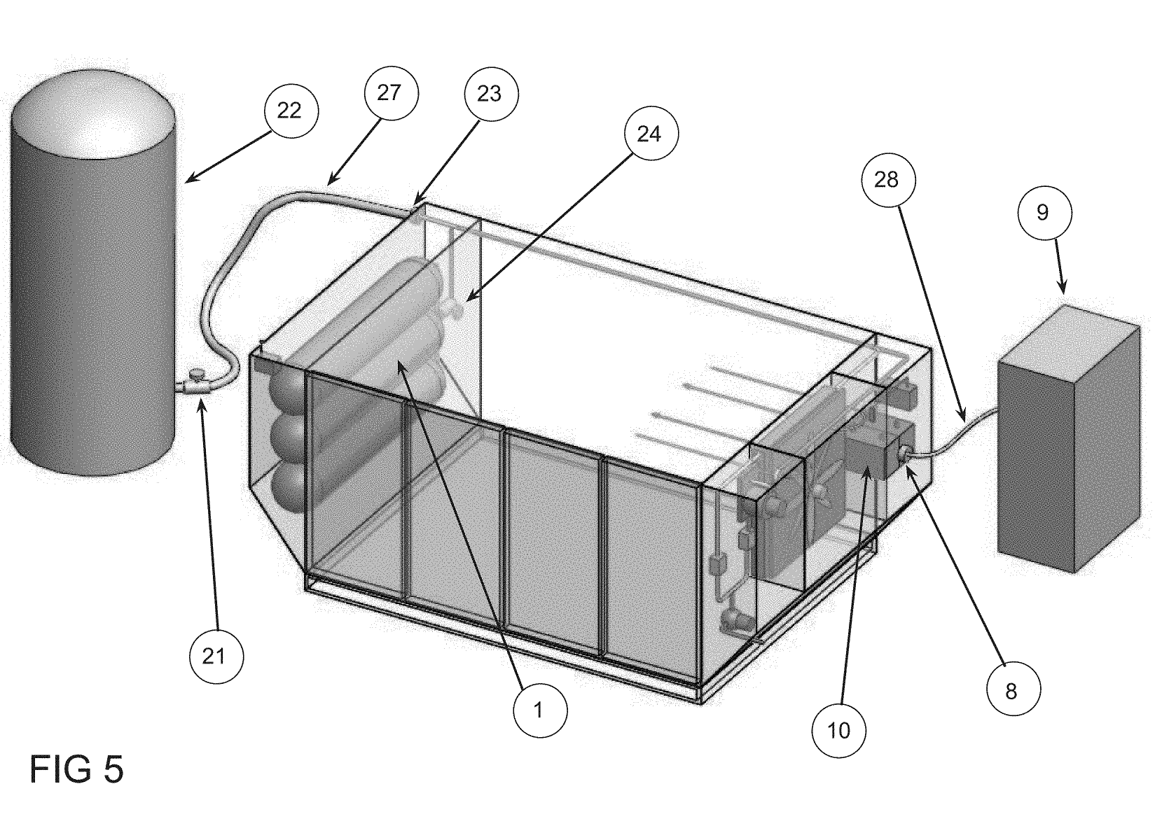

FIG. 5 shows one embodiment of the ULD during refueling and recharging. The ULD is refueled and recharged outside the aircraft and has quick connects for both the coolant 23 and the electrical power 8. The ULD is moved to a cryogenic bulk tank 22 and generator 9 location at the airport. Cryogenic bulk tanks can hold 30,000 gallons of liquid nitrogen and provide coolant for many ULD's on numerous flights. A cryogenic bulk tank 22 is attached to the quick connect 23 with hose 27. Valve 21 opens and liquid nitrogen fills the onboard cryogenic tanks 1. The quick connect 23 houses a check valve to prevent coolant leakage when hose 27 is removed. A manual valve may serve the same purpose. Deep cycle batteries 10 are recharged from a generator 9. Both the cryogenic bulk tank 22 and the generator 9 are located in the same area of the airport and connected and operate at the same time. Both a Stirling engine 11 and gas turbine generator 16 recharge deep cycle batteries 10 during normal flight operation. However, extended flights may require substantial heating. Thus, deep cycle batteries 10 may require additional energy that is supplied by generator 9. However, the recharge time will typically be limited to the 15 minute coolant fill time, which will be sufficient for battery recharge in most cases.

In one embodiment, the liquid nitrogen temperature-controlled device has the capability of cooling or heating the payload bay 19 and maintaining the predetermined setpoint temperature to within +/−2 deg C. in an air cargo compartment environment ranging from −40 to 50 deg C. for 10, 20, 30 or 90 days. Longer durations are possible with larger cryogenic tanks and deep cycle batteries.

In another embodiment, the controller 6 receives input from a thermal sensor 5, compares that temperature to a predetermined setpoint temperature and utilizes a Proportional Integral Derivative (PID) module that accurately maintains the payload bay 19 temperature.

In another embodiment, Operational data is recorded and stored in a data recorder and transmitter 7. Through telemetry a remote receiver monitors the operational data.

Cooling the payload bay 19 is accomplished as follows: When the payload bay 19 temperature is higher than the predetermined setpoint temperature, the controller 6 calls for cooling. The controller 6 communicates with and opens solenoid valve 17, which causes liquid nitrogen to flow from the cryogenic tanks 1 into and through the heat exchanger 2. The liquid nitrogen temperature as it enters the heat exchanger 2 is approximately −196 deg C., immediately providing substantial cooling in the heat exchanger 2. A fan 4 moves the air 18 through the heat exchanger 2 and throughout the payload bay 19 to ensure the customer product receives ample and uniform cooling by convection.

Heating the payload bay 19 is accomplished as follows: When the payload bay 19 temperature is colder than the predetermined setpoint, the controller 6 calls for heat. The controller 6 communicates with and energizes the electric heating element 3. The fan 4 moves the air 18 through the electric heating element 3 and throughout the payload bay 19 to ensure the customer product receives ample and uniform heating by convection.

Power is derived from the Stirling engine 11 as follows: The controller 6 detects the deep cycle battery voltage is below a preset threshold and opens solenoid valve 14 causing liquid nitrogen to flow from the cryogenic tanks 1 through the Stirling engine cold sink 13. The efficiency and power of a Stirling engine 11 is determined mainly by the temperature difference between the cold sink and the heat sink. Since the liquid nitrogen temperature entering the cold sink 13 is approximately −196 deg C. and the ambient temperature, the hot sink, is always warmer than −40 deg C., the temperature difference between the cold sink and the hot sink will always be greater than 156 deg C., thus providing the Stirling engine 12 sufficient energy to rotate a generator 12 that is connected directly to a Stirling engine 11. Generator 12 then recharges deep cycle batteries 7.

Power is derived from the gas turbine generator 16 as follows: When there is liquid nitrogen flowing from the cryogenic tanks 1 through the heat exchanger 2, or the Stirling engine cold sink 13, or both 2 & 13, the nitrogen gas evaporates as it absorbs heat and expands to 700 times the original liquid volume. Gas expansion is ideal for powering the gas turbine generator 16. Whenever there is a demand for cooling or a demand for operating the Stirling engine, expanded nitrogen gas flows through the gas turbine generator 16 and it delivers energy to recharge deep cycle batteries 10.

The payload bay 19 has double walls. Vacuum Insulated Panels (VIPs) 20 are placed between the walls to substantially reduce payload bay 19 thermal losses.

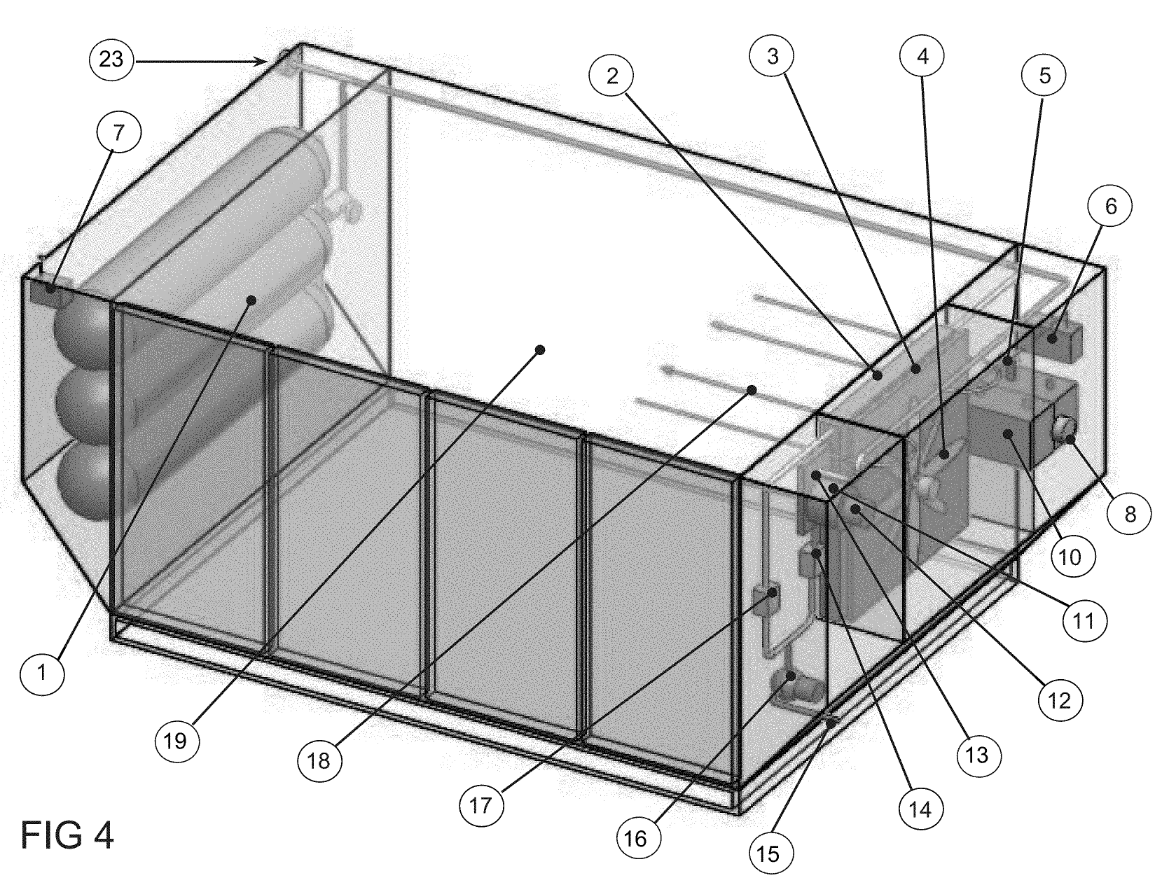

The payload bay 19 is box shaped with 4 doors for easy access to the contents of the payload bay. The entire thermal system is located in the two opposing sides of the ULD shown in FIG. 4, providing the unencumbered box shape compartment for ease of loading and unloading.

FIG. 5 shows the ULD during refueling and recharging. When “Active Shipping” is required, meaning the cryogenic tanks 1 inside the ULD contain liquid nitrogen and the ULD actively operates during transport, the cryogenic tanks 1 are filled prior to shipment from a cryogenic bulk tank 22 or service truck. Valve 21 controls the liquid nitrogen flow during the process of filling the cryogenic tanks 1. Supply line 27 is used to make the connection to the quick connect port 23 on the ULD. Also, the deep cycle batteries 10 are recharged with an electric source, such as an AC outlet or generator 9. This connection is made with a power line 28 at the quick connect port 8.

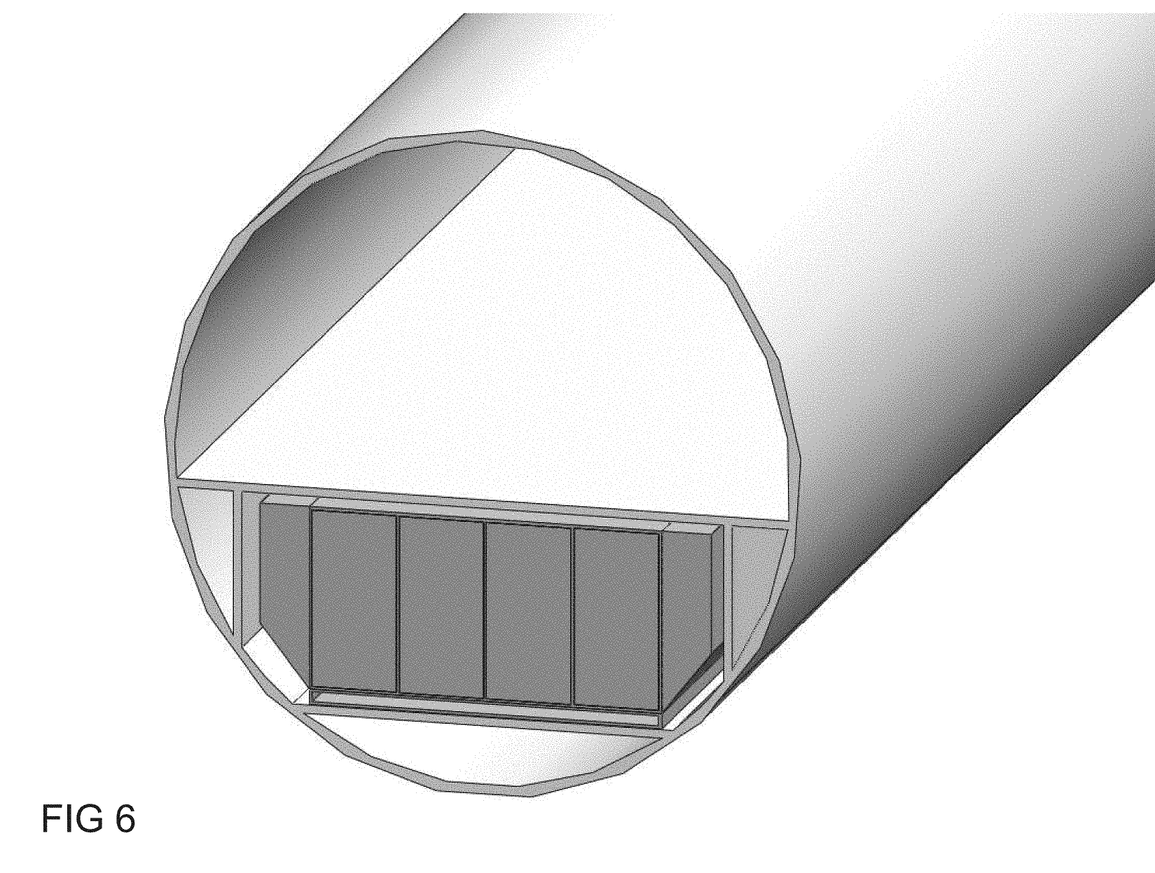

FIG. 6 shows a perspective view of the ULD in an aircraft. Standard ULDs are configured to fit in the belly of the aircraft. The temperature controlled ULD has exactly the same exterior dimensions as a standard ULD and will fit into cargo spaces designed for standard ULDs.

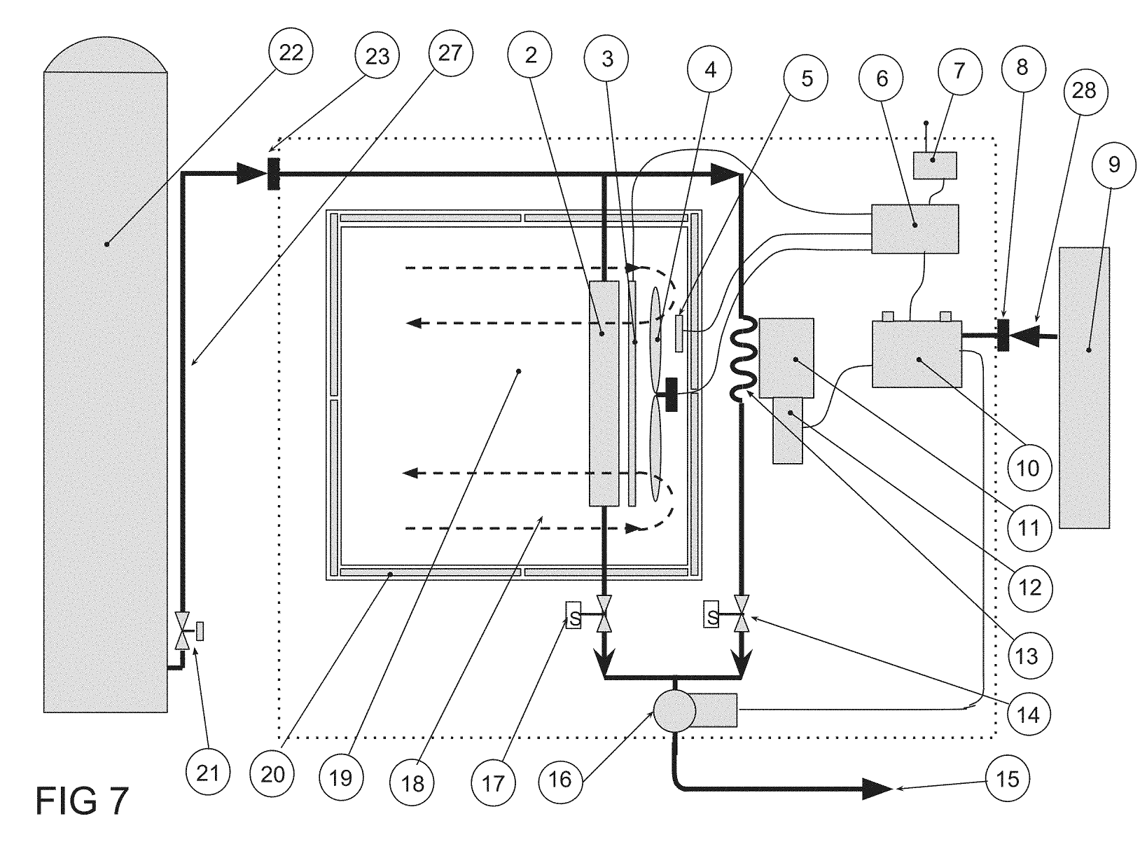

FIG. 7 shows an embodiment of ULD designed for use when coolant is not permitted during transport. This design called Passive Shipping ensures that the cryogenic tanks 1 inside the ULD are either removed completely as shown in FIG. 7, or remain onboard and are closed with a shut off valve 24 as shown in FIG. 1 to prevent any liquid nitrogen from entering the cryogenic tanks. Before boarding, the ULD is connected to an external cryogenic storage tank 22 or a liquid nitrogen service truck, and the coolant supply line 27 is attached to a quick connect port 23 on the ULD that is piped directly to the input of the heat exchanger 2. The ULD temperature controller 6 is turned on and the ULD operates using the external cryogenic storage tank 22 as the coolant source. An AC outlet or generator 22 is attached to quick connect 8 and supplies power for the fans 4, controller 6, and telemetry 7. When the predetermined temperature setpoint has been reached, the ULD is ready for transport and the supply hose 27 and power line 28 are disconnected from the unit.

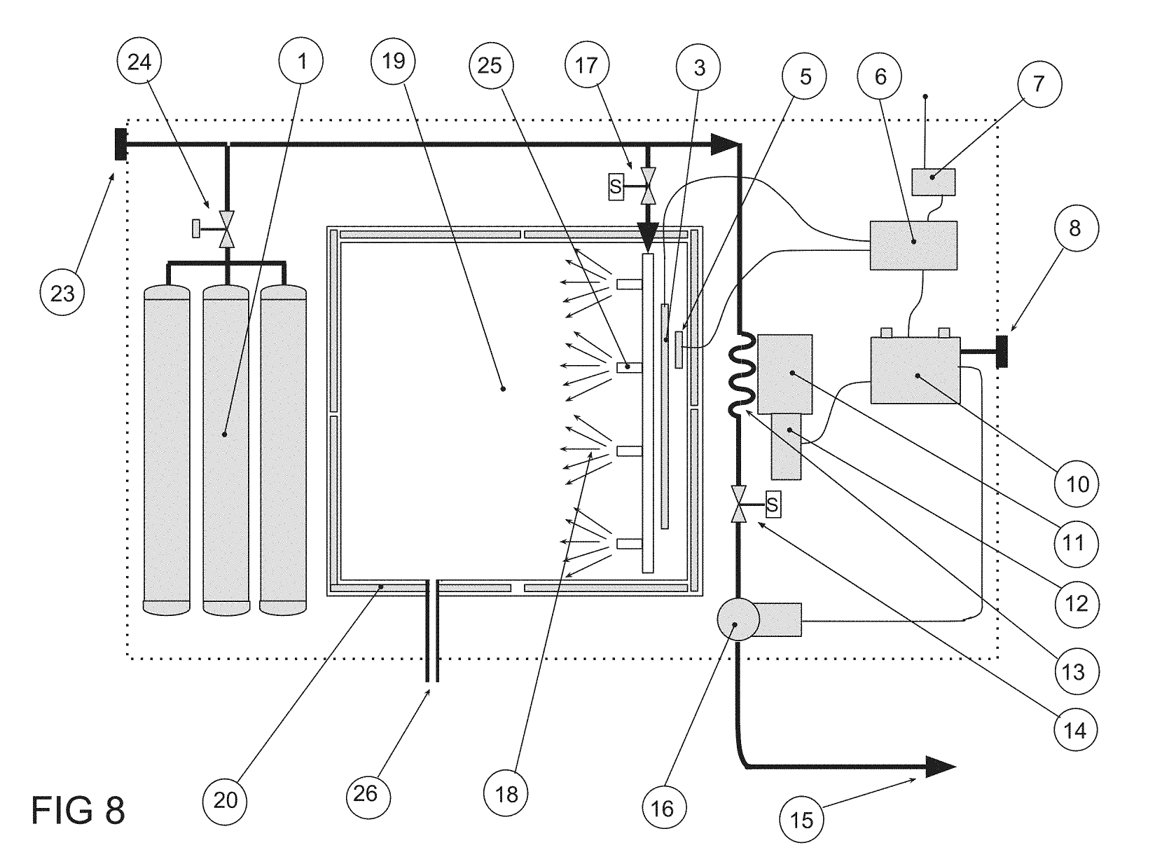

FIG. 8 shows another embodiment of the invention, an alternative method of cooling known as Direct Inject. The liquid nitrogen is sprayed 18 into the payload bay 19. The design eliminates the heat exchanger 2 and utilizes a tube with a multiplicity of nozzles 25. When there is a demand for cooling, the solenoid valve 17 is energized, and the liquid nitrogen flows from the cryogenic tanks 1, through the solenoid valve 17, through the tube, through the nozzles 25 and sprays 18 into the payload bay. The liquid nitrogen evaporates and provides extremely efficient cooling. The evaporated nitrogen gas increases the pressure of the payload bay, forcing the exhaust nitrogen gas through a vent pipe 26. Vent pipe 26 may be connected to a hose that vents outside the airplane. When the deep cycle batteries 10 require recharging, the controller 6 opens solenoid valve 14 that causes nitrogen to flow through the Stirling engine cold sink 13 and the gas turbine generator 16. Both the Stirling engine generator 13 and the gas turbine generator 18 deliver power to the deep cycle batteries 10.

Heat gains are minimized in the cryogenic plumbing by using stainless steel sheet metal surrounding the cryogenic piping that is vacuum sealed. These assemblies are referred to as Vacuum Jacketed Piping. Fittings for input and output connection in the assembly are configured and welded or bayoneted with cryogenic connectors in place. Preferably, the connection between the Vacuum Jacketed Piping is done with a bayonet connector that uses thermal contraction/expansion mechanisms. The contraction/expansion provides a mechanical connection for sections of Vacuum Jacketed Piping with a low heat gain connection. The bayonets are constructed of stainless steel with the nosepiece of the male bayonet being made from a dissimilar material such as the polymer INVAR36 to prevent mechanical seizing. A secondary O-ring seal is used at the flange of each bayonet half to provide a seal in which a gas trap is formed between the close tolerance fitting sections of the bayonet assembly. This gas trap is formed using the initial cryogen flow which is vaporized and forms a high-pressure impedance for the lower pressure liquid, thus forming a frost free connection with lowered heat gain to the cryogenic flow.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. An air freight unit load device (ULD) for an aircraft with a cargo bay, comprising:
an enclosure with
one or more cryogenic tanks;
a heat exchanger coupled to the one or more cryogenic tanks;
a Stirling engine having a cold sink coupled to the one or more cryogenic tanks;
a payload bay, isolated from the cargo environment, with a double wall and Vacuum Insulated Panels (VIPs) placed between the walls;
one or more valves coupling the one or more cryogenic tanks, the heat exchanger, and the Stirling engine; and
a controller coupled to the one or more valves and one or more sensors to maintain temperature of the payload at a predetermined temperature setpoint,
wherein the enclosure fits predetermined dimensions in the aircraft cargo bay, and wherein the cryogenic tank is adjacent is above an angled extension from a first wall and wherein the heat exchanger and Stirling engine are adjacent a second wall across from the first wall.

2. The device of claim 1, wherein the one or more cryogenic tanks store liquid nitrogen and the controller maintains the predetermined temperature setpoint.

3. The device of claim 1 wherein the controller receives temperature from a thermal sensor, compares the temperature to the predetermined temperature setpoint, and controls a Proportional Integral Derivative (PID) module to maintain a payload bay temperature.

5. The device of claim 1 comprising an electric heating element powered by deep cycle batteries.

6. The device of claim 1 comprising deep cycle batteries charged by a Stirling engine generator and a gas turbine generator.

7. The device of claim 1 wherein the pneumatic generator is powered by the residual exhaust gas expelled from the heat exchanger and the Stirling engine.

8. The device of claim 1, wherein the one or more cryogenic tanks comprise dewar tanks connected to each other in a parallel.

9. The device of claim 8, wherein the liquid nitrogen cryogenic tanks are periodically refueled from a liquid nitrogen cryogenic bulk tank or service truck and the batteries are recharged with an external generator or AC outlet.

10. (canceled)

11. The device of claim 1 wherein data is recorded and stored in a data recorder and a transmitter communicating with a remote receiver.

12. The device of claim 1, comprising a tube connecting the one or more cryogenic tanks to a heat exchanger and wherein one valve comprises a solenoid valve connected to the heat exchanger plumbing that opens the liquid nitrogen flow through the heat exchanger when there is a call for cooling.

13. The device of claim 1, comprising a tube connecting the one or more cryogenic tanks to a the cold sink and wherein one valve comprises a solenoid valve connected to the Stirling engine plumbing that opens the liquid nitrogen flow through the cold sink when there is a call to recharge the battery.

14. The device of claim 1, comprising a gas turbine generator plumbed to an exhaust line.

15. The device of claim 1, comprising an electric heating element in the payload bay.

16. The device of claim 1, comprising a fan inside the payload bay for convective heating and cooling.

17. The device of claim 1, comprising an exhaust hose that vents to the exterior of the aircraft.

18. (canceled)

19-20. (canceled)

21. The device of claim 1, wherein the Stirling engine charges a battery and wherein the controller detects battery voltage below a threshold and connects cryogen to a Stirling engine cold sink and wherein the Stirling engine rotates a generator to recharge the battery.
